(19) United States
(12) Patent Application Publication
(10) Pub. No.: US 2026/0165233 A1
(43) Pub. Date: Jun. 18, 2026

(54) APPLICATION OF AN AGRICULTURAL PRODUCT

(71) Applicant: BASF Digital Farming GmbH, Köln (DE)

(72) Inventors: Johannes Moritz STAEBLER, Köln (DE); Damon RAEIS-DANA, Köln (DE); Jonas MICKEL, Köln (DE); Chloe BEELMEON, Ecully (FR); Jerome CASADEBAIG, Lyon (FR); Hubert SCHMEER, Odenthal (DE)

(21) Appl. No.: 19/124,797

(22) PCT Filed: Oct. 24, 2023
(86) PCT No.: PCT/EP2023/079611

§ 371 Date: Apr. 25, 2025

(30) Foreign Application Priority Data
Oct. 27, 2022 (EP) 22204016.4

(51) Int. Cl. A01C 21/00; A01M 7/00

(52) U.S. Cl. CPC A01C 21/005; A01C 21/007; A01M 7/0089

(57) ABSTRACT

A computer-implemented method for generating a suitability index for the application of an agricultural product to a field with an application device is provided, wherein the method comprises providing vegetation data (302) associated with a biomass distribution on the field, providing machinery characteristics associated with a machinery footprint of the application device (202) on the field (108′), generating a machinery cell grid (305) from the machinery characteristics, wherein the machinery cell grid (305) comprises at least one cell (305a, 305b), generating a dosage cell grid (307) from the vegetation data and the machinery cell grid (305), wherein the dosage cell grid (307) indicates a dosage for the application of the agricultural product for the at least one cell (305a, 305b), generating a matching factor by matching the dosage cell grid and the vegetation data, generating the suitability index (309) based on the matching factor and providing the suitability index (309).

### TECHNICAL FIELD

The invention relates to computer-implemented method for generating a suitability index for the application of an agricultural product to a field with an application device, to a computer program product for generating a suitability index for the application of an agricultural product to a field with an application device, to an apparatus for generating a suitability index for the application of an agricultural product to a field with an application device, to a computer-implemented method for generating a variable rate application instruction for the application of an agricultural product to a field with an application device, to an apparatus for generating a variable rate application instruction for the application of an agricultural product to a field and to an agricultural machinery for application of an agricultural product to a field.

### TECHNICAL BACKGROUND

The present disclosure relates, in general terms to the technical field of farming. In particular the present disclosure relates to the technical field of digital farming.

In modern digital farming, field mapping techniques are used to measure in-field variability of environmental factors that affect crop growth. This allows for the creation of different management zones such that seasonal input measures like crop protection are tailored to local field conditions. Commonly used are biomass maps, as these can be generated from remotely sensed or in-field measurements. These paint a field-centric picture of the status of someone's crop and allow for cross-field and field history comparability.

However, long-time experience is necessary to interpret such maps and asses the appropriateness of application maps generated from them.

### SUMMARY

Hence, there is a need for an efficient way to evaluate the potential benefits of in-field variable application maps.

In an aspect the subject matter of the invention is provided in the independent claims. Further aspects and/or embodiments are provided in the dependent claims.

In an aspect the disclosure relates to a computer-implemented method for generating a suitability index for the application of an agricultural product to a field with an application device, the method comprising the following: providing vegetation data associated with a biomass distribution on the field, providing machinery characteristics associated with a machinery footprint of the application device on the field and generating a machinery cell grid from the machinery characteristics. The machinery cell grid comprises at least one cell. In an example a cell is a substantially geometric element such as a polygon, a square, rectangle and/or a hexagon. The cell is used for dividing a surface, a region and/or an area in addressable and individually controllable subunits.

The method further comprises generating a dosage cell grid from the vegetation data and the machinery cell grid, wherein the dosage cell grid indicates a dosage for the application of the agricultural product for the at least one cell. In an example the dosage per cell is uniformly allocated to the cell. In other words, the cell may substantially have within the cell boundaries the same dosage regime and/or dosage quantity.

In addition, the method comprises generating a matching factor by matching the dosage cell grid and the vegetation data, generating the suitability index based on the matching factor and providing the suitability index.

In another aspect the disclosure relates to a computer program product for generating a suitability index for the application of an agricultural product to a field with an application device, wherein the computer program product comprises program code, which when executed by a processor is configured to carry out the method for generating a suitability index for the application of an agricultural product to a field with an application device.

In yet another aspect the disclosure relates to a computer readable medium comprising program code, which when executed by a processor is configured to carry out the method for generating a suitability index for the application of an agricultural product to a field with an application device.

According to a further aspect the disclosure relates to an apparatus for generating a suitability index for the application of an agricultural product to a field with an application device, the apparatus comprising a vegetation data device for providing vegetation data associated with a biomass distribution on the field and a machinery data device for providing machinery characteristics associated with a machinery footprint of the application device on the field.

The apparatus further comprises a machinery cell grid device for generating a machinery cell grid from the machinery characteristics, wherein the machinery cell grid comprises at least one cell.

The apparatus also comprises a dosage cell grid device for generating a dosage cell grid from the vegetation data and the machinery cell grid, wherein the dosage cell grid indicates a dosage for the application of the agricultural product for the at least one cell.

The apparatus has a suitability index generation device for generating a matching factor by matching the dosage cell grid and the vegetation data and for generating the suitability index based on the matching factor.

Furthermore, the apparatus has an output device for providing the suitability index.

In a further aspect the disclosure relates to a computer-implemented method for generating variable rate application instructions for the application of an agricultural product to a field with an application device.

The method comprises providing vegetation data associated with a biomass distribution on the field and providing machinery characteristics associated with a machinery footprint of the application device on the field.

Furthermore, the method provides for generating a machinery cell grid from the machinery characteristics, wherein the machinery cell grid comprises at least one cell. And the method provides for generating a dosage cell grid from the vegetation data and the machinery cell grid wherein the dosage cell grid indicates a dosage for the application of the agricultural product for the at least one cell.

The method further comprises generating the variable rate application instructions based on the dosage cell grid and providing the variable rate application instructions for the application of the agricultural product to the field with the application device.

In another aspect the disclosure relates to a computer program for generating variable rate application instructions for the application of an agricultural product to a field with an application device, wherein the computer program product comprises program code, which when executed by a processor is configured to carry out method for generating variable rate application instructions for the application of an agricultural product to a field with an application device.

In yet another aspect the disclosure relates to a computer readable medium comprising program code, which when executed by a processor is configured to carry out the method for generating variable rate application instructions for the application of an agricultural product to a field with an application device.

In a further aspect the disclosure relates to an apparatus for generating variable rate application instructions for the application of an agricultural product to a field.

The apparatus comprises a vegetation data device for providing vegetation data associated with a biomass distribution on the field and a machinery data device for providing machinery characteristics associated with a machinery footprint of the application device on the field.

The apparatus further comprises a machinery cell grid device for generating a machinery cell grid from the machinery characteristics, wherein the machinery cell grid comprises at least one cell. In addition, the apparatus has a dosage cell grid device for generating a dosage cell grid from the vegetation data and the machinery cell grid, wherein the dosage cell grid indicates a dosage for the application of the agricultural product for the at least one cell.

Furthermore, the apparatus comprises a variable rate application generation device for generating the variable rate application instructions based on the dosage cell grid.

To provide the variable rate application instructions for application of the agricultural product to the field with the application device the apparatus has an output device.

In an aspect the disclosure relates to an agricultural machinery for applying an agricultural product to a field, wherein the agricultural machinery is configured for receiving the variable rate application instructions generated by the method for generating variable rate application instructions for the application of an agricultural product to a field with an application device.

The agricultural machine or the agricultural machinery is further configured for applying the agricultural product according to the received variable rate application instructions.

In another aspect the disclosure relates to a digital map, in particular a variable rate application map, that is uploadable to an application device. The map comprises location-based dosage information, wherein the location-based dosage information comprises geographical data. In an example the map comprises dosage information allocated to geographical coordinates. This location-based dosage information is adapted to form a dosage cell grid when the location-based dosage information is arranged on a geographical map according to the geographical data. The dosage cell grid comprises at least one cell of substantially equal dosage values, wherein the at least one cell of substantially equal dosage values has a dimension that is associated with the machinery footprint of the application device.

Such a map may be seen as an application instruction for applying an agricultural product to a field and/or as a set of instructions for applying an agricultural product to a field. In an example, such instruction may be generated by an apparatus for generating variable rate application instructions.

The digital map may be provided in the GPX-format. When visualized such a digital map and/or such an overlay map may have a mosaic structure. Due to the mosaic structure the map differs from a mere representation of satellite measured vegetation indices provided in zones. The association with the application device may consider sprayer specificity in a “to apply map”, i.e. in a map that is applied in an application device. In another example also ramping up prior high productivity areas and/or ramping down after high productivity areas may be visible in the map. In this way the instructions provided by the subject-matter of the present disclosure may differ from other instructions and/or from other maps that are available in the market.

In another example the map may comprise the turning and/or the shifting of tramlines.

Any map, e.g. the digital map, the vegetation data map, the variable rate application map, or the dosage cell grid, may be provided as farming operation map. A digital map may be used in a field management system.

### EMBODIMENTS

In the following, terminology as used herein and/or in the technical field of the present disclosure will be outlined by ways of embodiments and/or examples. Where examples are described, it is to be understood that the present disclosure is not limited to said examples.

The suitability index may be seen as a zone-based heterogeneity index. The suitability index may indicate an extent to which a field's heterogeneity indicated by a biomass distribution may be matched by a predefined application concept for the agricultural product.

In an example an application concept for the agricultural product and/or for applying an agricultural product to a field is a Variable Rate Application (VRA) or flat application. For VRA the agricultural product may be distributed with substantially locally differentiating rates and/or with heterogeneous rates. For a flat application the application rate may substantially be equal or homogeneous. The different concepts may be used for Seeding(S), Fertilizing (F) and/or Crop-protection. In order to refer to general application of a material the term VRx may be used, where x may be used for the relevant material. VRA may refer to providing a product and/or a liquid with a variable rate, VRS may refer to seeding with a variable rate and VRF may refer to applying fertilizer with a variable rate.

In other words, one example for an application concept for the agricultural product is a flat application where the application rate may substantially be equal or homogeneous over a predefined area, region and/or a field. This means that even an environmental parameter is heterogeneously distributed and changes within the borders of the predefined area, region and/or field the application rate may substantially stays homogeneous. In this way the predefined area, region and/or field may be treated substantially in the same way. Environmental parameter may be parameter such as a soil property, biomass, elevation or slope.

In contrast to the flat application concept a Variable Rate Application (VRA) concept is a concept with varying application rates substantially associated with an heterogenous environmental parameter. For VRA the agricultural product may be distributed with substantially locally differentiating rates and/or with heterogenous rates. In this way different sub-areas or sub-regions of a predefined area, region and/or field may be treated with different dose rates, for example to consider variations of soil properties, soil data and/or soil characteristics.

In general, the term “application rate” and/or “dose rate” is understood as an amount of product to be applied per area, sub-area or sub-region, for example expressed as liter per hectare (L/ha). The dose rate may be locally varied.

In an example the application device is a boom comprising at least one sprayer and/or one seeder.

In an example the agricultural product may be a “crop protection product”. A crop protection product is a product selected from the group consisting of a fungicide, herbicide, insecticide, acaricide, molluscicide, nematicide, avicide, piscicide, rodenticide, repellent, bactericide, biocide, safener, plant growth regulator, urease inhibitor, nitrification inhibitor, denitrification inhibitor, or any combination thereof.

The application rate may be adapted to a biomass distribution on the field and thus may allow for compensating any defects and/or for providing individual treatments to a specific area of the field.

Computer applications like field manager applications exist which may allow to evaluate biomass distributions of a predefined region and/or a predefined field and support creating field-specific, variable rate application (VRA) maps for seeds, fertilizers, crop protection and plant growth regulators. The VRA maps are based on satellite in-season biomass images.

Different application concepts may exist for applying an agricultural product to an area, to a region and/or to a field.

The suitability index may be associated with the degree of matching between the application rate per cell and the vegetation data. In other words, the suitability index may indicate how well a substantially round and/or curved distribution of biomass is covered by a cell structure generated by the application device. Thus, the suitability index may indicate how well an application concept and/or an application device is feasible for a particular biomass distribution.

The actual rate for applying the agricultural product may depend on a position in the region and/or on the field. Such a position may be derived from a Global Navigation Satellite System (GNSS) and/or a Real-time kinematic positioning (RTK) system. Examples for GNSS systems are the Global Positioning System (GPS), Global Navigation Satellite System (GLONASS), BeiDou Navigation Satellite System Galileo, Quasi-Zenith Satellite System (QZSS) and the Indian Regional Navigation Satellite System (IRNSS).

Biomass data and/or a biomass distribution may be provided as map data of a digital map. In a specific example biomass data may be provided as meta data and/or as an overlay map to a digital map. Such metadata may be provided in the GPX Format (GPS Exchange Format). The GPX format defines an XML (Extensible Markup Language) schema and/or an XML data structure that may be used to exchange data for digital maps.

The term “field” and/or “agricultural field” in an example may be understood to be any area in which organisms, particularly crop plants, are produced, grown, sown, and/or planned to be produced, grown or sown. The term “agricultural field” may also include horticultural fields, silvicultural fields and fields for the production and/or growth of aquatic organisms.

A field and/or an agricultural field may be represented as a digital map and/or as a sub region of a digital map.

An AB-line is a tramline, a track and/or path which the application device follows during operation, e.g. during applying the agricultural product to the field. In an example the AB-line is directed from a starting position in the field to the headland of the field.

The headland of the field is the side of the field opposite to the starting position. The length of the headland is smaller than or equal to the length of the field at the starting position. The AB-line provides an orientation and/or a bearing during the operation of the application device. At least one AB-line may be arranged on a field to support efficiently covering substantially all areas of a field when the application device moves along the AB-line.

Information about a biomass distribution may be gathered in different ways. In one example biomass distribution may be provided by evaluating satellite photos. In another example a biomass distribution is provided by collecting and registering an environmental sample.

An “environmental sample” may refer to any kind of sample that is collected from the geographical location or the surrounding area, for example, for analysis such as detecting the presence of a harmful organism or pathogen. The environmental sample may or may not comprise a portion of the crop at the geographical location. The environmental sample may be collected from any one or a combination thereof of: air, water, inorganic or organic matter from the geographical location or crop site or field that comprises the geographical location. For example, the environmental sample may be a soil sample obtained from the geographical location or crop site, and/or it may be a foliage or other organic matter such as mulch, humus or composted matter. The environmental sample may even be pollen collected either directly from the crop or on-site from air. It will thus be appreciated that the environmental sample can be any one or more of the: whole plant, plant parts such as leaf, root, flower, pollen, soil samples, spore collections (e.g., on filter paper). A foliage or leaf sample may comprise a part of the crop, or it may just be a weed foliage or a weed plant part. When a sample is collected from air on-site, indicators of the organism such as spores, traces, etc. may be collected. In some cases, the sample may comprise an organism or microorganism, e.g., in the form of an insect or a part thereof. The environmental sample may be used to analyse any one or more of soil properties or measurements such as pH value, water hardness, mineral concentration, crop properties for example for determining crop health, presence of any one or more undesired features such as pathogens and presence of any one or more desired features such as favorable organisms or microorganisms.

“Field specific data” refers to data related to a field to which a geographical location is associated with. A relation to the field is assumed either by being located within a certain distance from the field, or by the geographical location being a part of the field.

Field specific data may comprise a biomass distribution and/or soil data.

Soil data relating to the field or the sub-field zone in an example include soil organic matter, total carbon content, organic carbon content, inorganic carbon content, soil humus content, boron content, phosphorus content, potassium content, nitrogen content, sulfur content, calcium content, iron content, aluminium content, chlorine content, molybdenum content, magnesium content, nickel content, copper content, zinc content, Manganese content, and/or pH value of the soil in the field or the sub-field zone; and/or soil quality, soil sandiness, soil moisture, soil humidity, soil temperature, soil surface temperature, soil density, soil texture, soil conductivity, water holding capacity, clay content, sand content, silt content, and/or sand content of the soil in the field or the sub-field zone.

The term “zone” is understood to be a sub-field zone or a part of an agricultural field, i.e. an agricultural field may be spatially divided into more than one zone, wherein each zone may have different properties such as different biomass levels or different weed and/or pathogen infestation risks.

A biomass distribution may comprise a plurality of biomass zones. A biomass zone may be defined as an area on a field having substantially the same biomass properties within a specific area.

Other ways of describing a biomass distribution may be a variogram based approach. A variogram uses spatial statistic parameters to describe the biomass distribution. The Variogram parameters like the variogram range and sill describe the spatial dependency structure, based on which metrics such as the Cambardella Index and/or a mean correlation distance may be derived to specify the spatial distribution of a property such as a biomass value.

In contrast to a zone-based approach for classifying the biomass distribution a variogram based approach focuses on point-based measurements.

A further approach to describe a biomass distribution is the use of a Grey-Level Co-Occurrence Matrix (GLCM). In this approach a statistical method is used for examining a texture and the spatial relationship of pixels is considered. Measures like the GLCM entropy, GLCM autocorrelation or GLCM cluster tendency are used to specify the spatial distribution of a property such as a biomass value, these metrics can be computed by using mathematical program libraries.

In contrast to using a zone-based approach for classifying the biomass distribution, a grey level-based approach focuses on digital imaging processing-based measurements. There may not be a direct link to the biomass.

In an embodiment a processor may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor-based processor, a quantum processor, or any other type of processor configures for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

A processor may also be a subpart of a processor which is executing the method in form of a thread, a container and/or a virtual machine.

In an embodiment a computer readable medium may be volatile, non-volatile storage and/or memory. The computer readable medium may include non-volatile mass storage such as physical storage media. The computer readable medium may be a storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system.

Moreover, the memory may be a computer-readable media that carries computer-executable instructions. Another name for a computer-readable media may be a transmission media.

Further, upon reaching various computing system components, program code may comprise computer-executable instructions or data structures can be transferred automatically from transmission media to storage media or vice versa. For example, computer-executable instructions or data structures received over a network or data link can be buffered in RAM within a network interface module (e.g., a “NIC”), and then eventually transferred to computing system RAM and/or to less volatile storage media at a computing system. In an example a storage media may be included in computing components that also utilize transmission media.

In an embodiment each of the computer implemented invention may be realized as an application. Such an application may run on computer hardware.

In combination with computer hardware the application may be provided as the apparatus for generating a suitability index for the application of an agricultural product to a field with an application device and/or as the apparatus for generating a variable rate application instruction for the application of an agricultural product to a field.

Such hardware may be connected to an agricultural machinery in order to provide the suitability index and/or the variable rate application instructions to the application device, e.g. to the agricultural machinery.

The connection between any of the described apparatuses and the application device may be via a wired and/or a wireless connection. In another example the data transfer may use a computer readable medium such as a USB stick for transferring the data, index, and/or the instructions.

In an embodiment a wireless communication protocol may be used. The wireless communication protocol may comprise any known network technology such as GSM (Global System for Mobile Communications), GPRS (General Packet Radio Services), EDGE (Enhanced Data Rate for GSM Evolution)/HSPA (High Speed Packet Access), UMTS (Universal Mobile Telecommunications System), LTE (Long Term Evolution) technologies using standards like 2G, 3G, 4G or 5G. The wireless communication protocol may further comprise a wireless local area network (WLAN), e.g. Wireless Fidelity (Wi-Fi).

In an embodiment the machinery characteristics relate to a physical and/or functional setup of the application device. In this way the machinery footprint may be a virtual footprint that is defined by the position of a part of an application device such as a sprayer or boom, by an application time of an agricultural product and/or by the reaction time of a part of the application device.

In another embodiment the method for generating a suitability index further comprises providing an application concept for the application of the agricultural product to the field with the application device, wherein generating the machinery dosage cell grid comprises considering the application concept.

The application concept may comprise a rule set for applying the agricultural product to a field. In an example the concept may provide for applying the agricultural product according to a VRA application schema and/or a VRx application schema. In another example the concept may provide for applying the agricultural product according to a flat application schema.

The concept may be defined by an instruction and/or by a set of instructions that controls/control the application device and any sub-device of the application device. Such control instruction may comprise a location-based dose rate. However, for generating the suitability index a simulation is executed taking into account the application of the respective application concept.

In other words, the machinery dosage cell grid is a model that simulates the application of the agricultural product with the application device by using the respective application concept. In addition, the physical parameters of the application device are taken into account in order to end up with a machinery dosage cell grid which indicates the different dose rates that might be used at the various locations of the machinery dosage cell grid. The machinery dosage cell grid may consider physical restrictions of the application device such as the fact that a cell is the smallest geographical entity within which the dose and/or an application rate may be varied.

In an example the machinery dosage cell grid may have a rectangular shape while the vegetation data may have a round and/or curve-based shape.

In a further embodiment the application concept is at least one application concept selected of the list of application concepts consisting of an agronomic rule, a variable rate application (VRA) rule and a flat rate application rule the application rate cell.

The different application concepts may relate to different operation modes of the application device. If a plurality of operation modes is provided by the application device the suitability index may be generated and/or calculated for each application concepts and the suitability index may help to select the most efficient application concept for a predetermined field.

In another embodiment generating the machinery cell grid from the machinery characteristics includes at least one of determining the machinery footprint of the application device on the field from a physical dimension of the application device, from control settings of the application device and/or from a reaction time of the application device.

A physical dimension of the application device may be determined by the physical length of the application device. The application device may be a boom having a length selected from a range of 20 m to 40 m. In another example the boom may have a length selected from the range of 10 m to 35 m. In a further example the boom may have at least one nozzle and/or at least one sprayer mounted to the boom. Such a sprayer may allow for covering a certain region dependent on the spaying pattern of the sprayer. A spraying pattern may be set up by selecting a modulation schema fur the activation of the nozzle.

Furthermore, such a sprayer may have a predefined operation time and/or a predefined reaction time. This reaction and/or operation time in combination with the physical extension of the application device may define the machinery cell grid. In particular a cell of the machinery cell grid may be defined by these parameters.

In a further embodiment generating the machinery cell grid from the machinery characteristics includes generating the machinery cell grid based on a sub element of the application device, wherein the sub element is a part of the application device for which the application concept of the agricultural product is separately controllable.

In case of a plurality of sprayer equidistantly arranged along the boom the plurality of sprayer may form the smallest sub elements of the application device that may be controlled on a separate basis.

In yet another embodiment generating the dosage cell grid comprises determining differences between cells, identifying a buffer cell by the differences and assigning an intermediate dosage of the agricultural product to the buffer cell.

In this way strong dosage changes between individual cells of the dosage cell grid may be prevented, ramped up and/or ramped down.

The dosage cell grid may be generated by determining the number of biomass zones extending inside a cell of the machinery cell grid.

In another embodiment generating the dosage cell grid includes projecting the machinery cell grid in at least one predetermined orientation to the vegetation data and determining the dosage and/or the dose rate for the application of the agricultural product per cell for the at least one predetermined orientation of the machinery cell grid.

The machinery cell grid is projected to the ground and/or to the surface of the field comprising the biomass distribution. The biomass distribution may be arranged in round zones. The smallest controllable unit of the application device may be a cell. Such a cell may have a polygonal shape and therefore may not cover all the round zones. Dependent on the respective arrangement of the biomass distribution zones the machinery cells may match the biomass distribution zones to a greater or lesser extent. In this way discrepancies with regard to the resolution may arise.

In a further embodiment generating the suitability index based on the matching factor further comprises considering the at least one predetermined orientation of the machinery cell grid.

Comparing different orientations and/or different bearings of the machinery cell grid may help to find a good matching factor and a high suitability index. The orientation is provided as an angle value in reference to a reference orientation such as a south-north direction and/or to a meridian.

In yet another embodiment the method further comprises determining a tramline for the application device based on the at least one predetermined orientation of the machinery cell grid.

The tram line and/or AB-line is a path to be followed by the application device when treating the field.

In another embodiment the method further comprises providing the dosage cell grid as variable rate instructions for the application of the agricultural product to the field with the application device.

As the dosage cell grid indicates a dosage for the application of the agricultural product for the at least one cell, the dosage cell grid in an example may be taken as the basis for deriving instructions for controlling the application device when moving over the field. The application device may have a corresponding control device that is adapted to receive the control instructions and/or to execute the control instructions.

In another embodiment the variable rate instructions include a variable rate application map indicating the application rate per cell and/or a tramline for the application device.

The variable rate application map may be a digital map and may be based on the dosage cell grid. The variable rate application map may be transferred from an apparatus for generating a suitability index for the application of an agricultural product to a field with an application device to a reading device of the application device. The variable rate instructions and/or the variable rate application map may be used to control the application device in such a way that the agricultural product is provided to the field in accordance with the respective application rate per cell.

The application device may be an autonomously operating agricultural machinery and/or a part of an agricultural machinery. During the application of the agricultural product the application device substantially follows the tramline. In an example the navigation information and/or the dosage information may be read from the digital map and/or from the variable rate application map.

In the present disclosure some aspects are described with regard to product type claims some aspects are described with regard to method type claims. It is to be understood that subject-matter described for product type claims may be also valid for method type claims and vice versa.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1 illustrates a machine as part of a distributed computing environment according to an exemplary embodiment of the present invention.

FIG. 2 illustrates a spray device according to an exemplary embodiment of the present invention.

FIG. 3 illustrates a block diagram of an apparatus for generating a suitability index according to an exemplary embodiment of the present invention.

FIG. 4 illustrates a block diagram of an apparatus for generating a variable rate application instruction according to an exemplary embodiment of the present invention.

FIG. 5 illustrates a creation schema for generating a machinery cell grid from the machinery characteristics according to an exemplary embodiment of the present invention.

FIG. 6 illustrates a vegetation data map with biomass zones according to an exemplary embodiment of the present invention.

FIG. 7 illustrates a dosage cell grid for variable rate application according to an exemplary embodiment of the present invention.

FIG. 8 illustrates a perspective view of a dosage cell grid according to an exemplary embodiment of the present invention.

FIG. 9 illustrates a dosage cell grid for a flat application of an agricultural product according to an exemplary embodiment of the present invention.

FIG. 10 illustrates a difference image between a vegetation data map and a dosage cell grid for variable rate application according to an exemplary embodiment of the present invention.

FIG. 11 illustrates a difference image between the vegetation data map and a dosage cell grid for flat application according to an exemplary embodiment of the present invention.

FIG. 12 illustrates a user interface according to an exemplary embodiment of the present invention.

FIG. 13 illustrates a series of index generation with different orientations according to an exemplary embodiment of the present invention.

FIG. 14 illustrates a detail view of an overlay of a vegetation data map with a machinery cell grid according to an exemplary embodiment of the present invention.

FIG. 15 illustrates a flow chart for a method of choosing a dose for a cell according to an exemplary embodiment of the present invention.

FIG. 16 illustrates a schema for defining thresholds for biomass zone types according to an exemplary embodiment of the present invention.

FIG. 17 illustrates examples for allocating a dosage value to a polygon according to an exemplary embodiment of the present invention.

FIG. 18 illustrates a dosage cell grid according to an exemplary embodiment of the present invention.

FIG. 19 illustrates a dosage cell grid with a buffer cell according to an exemplary embodiment of the present invention.

FIG. 20 illustrates a high-level block diagram for a method for generating variable rate application instructions for applying an agricultural product to a field according to an exemplary embodiment of the present invention.

FIG. 21 illustrates a method for generating variable rate application instructions for the application of an agricultural product to a field with an application device according to an exemplary embodiment of the present invention.

### DETAILED DESCRIPTION

The following embodiments are mere examples for implementing the method, the system or application device disclosed herein and shall not be considered limiting.

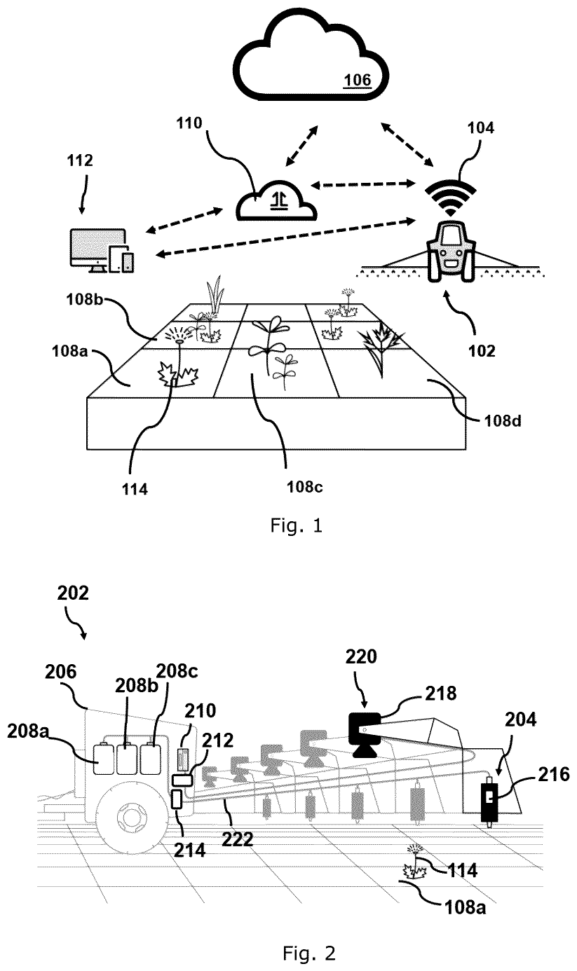

FIG. 1 illustrates a machine 102 shown here as part of a distributed computing environment according to an exemplary embodiment of the present invention. The machine 102 is used for performing and/or conducting an agricultural farming operation on a field which comprises a plurality of geographical locations 108. The farming operation may be a treatment for a crop which comprises a crop plant 114 located at a first geographical location 108a. The farming operation may even relate to a control or eradication of weed plants.

The machine 102 may be a smart sprayer and it may include a connectivity interface 104. The connectivity interface 104 may either be a part of a network interface, or it may be a separate unit. In this drawing for simplicity it is assumed that the connectivity interface 104 and the network interface are the same unit. The connectivity interface 104 is operatively coupled to a computing unit (not shown explicitly in FIG. 1). The computing unit is operatively connectable to the machine 102. The connectivity interface 104 is configured to communicatively couple the machine 102 to the distributed computing environment. The connectivity interface 104 can be configured to provide field specific data at the computing unit. Moreover, the connectivity interface 104 can also be configured to provide update data, for example collected at the machine 102 to any one or more remote computing resources 106, 110, 112 of the distributed computing environment. Any one or more of the computing resources 106, 110, 112 may be a remote server 106, which can be a data management system configured to send data to the machine 102 or to receive data from the machine 102. For example, as detected maps or as farming operation maps comprising update data recorded during the farming operation on a geographical location 108a may be sent from the machine 102 to the remote server 106, shown in this example as a cloud based service.

Any one or more of the computing resources 106, 110, 112 may be a field management system 110 that may be configured to provide a control protocol, an activation code or a decision logic, or in general field specific data, to the machine 102 or to receive data, for example, update data, from the machine 102. Alternatively, or in addition, such data may be received by the field management system 110 via the remote server 106 or data management system. Any one or more of the computing resources 106, 110, 112 may be a client computer 112 that may be configured to receive client data from the field management system 110 and/or the machine 102. Such client data may include for instance farming operation schedule to be conducted on one or more fields or on the plurality of geographical locations 108 with the machine or field analysis data to provide insights into the health state of certain one or more geographical locations or field. The client computer 112 may also refer to a plurality of devices, for example a desktop computer and/or one or more mobile devices such as a smartphone and/or a tablet and/or a smart wearable device.

The machine 102 may be at least partially equipped with the computing unit, or the computing unit may be a mobile device that can be connected to the machine, via the connectivity interface 104. It will be appreciated that the field management system 110 and the remote server 106 may be the same unit. The computing unit may receive the field specific data either via the client computer 112, or it may receive it directly from the remote server 106 or the field management system 110.

In particular when data such as update data is recorded by the machine 102, such data may be distributed to any one or more of the computing resources 106, 110, 112 of the distributed computing environment.

Now including reference to FIG. 2, the machine 102 may for instance include a spray device 202 including a monitoring system 212 for monitoring dissemination, for example, spray application of one or more agricultural substances. In one example, monitoring of one or more spray nozzles 204 may be done via one or more sensors, for example, sensor 214 and sensor 216. The sensors 214, 216 may be built into the fluidic system of the spray device 202. Such sensors 214, 216 may be placed in the common fluidic line 222 of a subset of spray nozzles 204, or for all spray nozzles 204. Together with one or more activation signals for controlling valves of the spray nozzles 204 and/or their associated tank(s), the machine 102 or spray device 202 has sufficient information to determine, e.g. deviations of the measured fluid property from the expected fluid property, and/or a spray nozzle specific fluid property, and/or a fluid property as measured by the sensor in the fluidic line, and/or a spray nozzle position causing deviations.

In another example, e.g. in cases where no sensors 214, 216 are available, the spray device 202 and in particular spray nozzles 204 are controlled by a variable rate application instruction provided via one of computing resources 106, 110, 112 and/or loaded to the machine 102 or spray device 202 via a computer-readable medium. In this example the monitoring system 212 is optional and may be used to generate vegetation data and/or biomass data.

Control data may be derived from a digital map and/or a digital overlay map that is loaded on machine 102, on spray device and/or on application device 202.

Any form of data, for example, the update data, may be recorded during the farming operation and transferred to e.g. the remote server 106 in real-time during the farming operation or spraying, and/or the data may be transferred after the farming operation is conducted. The latter may be the case for example if a network connection for transferring the data is not available during the farming operation. Based on update data any suboptimal or unsuitable farming operation conducted on the agricultural area or one or more geographical locations 108 may be analyzed.

FIG. 2 shows further a non-limiting example of the spray device 202. For the sake of clarity FIG. 2 is a principle sketch, where the core elements are illustrated. In particular, the fluidic set up shown is a principle sketch and may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also, different fluidic set ups and mixing arrangements may be chosen. The teachings related to this example are, however, applicable to all dissemination setups, which have at least one common fluidic line serving a subset of spray nozzles or all spray nozzles with one or more fluids. Moreover, it will be appreciated that dissemination of one or more agricultural substances is non-limiting to the generality of the present teachings, as the teachings may be applied also to farming operations that do not involve a dissemination.

Further moreover, those skilled in the art will realize that other farming operations such as aquatic farming operations being conducted via a suitable machine operatively connected to a computing unit pursuant to the present teachings are also possible as outlined in the present disclosure.

The machine 102 of FIG. 2 may comprise a tractor (not shown in FIG. 2) operatively attached or mounted with a spray device 202 for disseminating an agricultural substance, for example application of a pesticide, a herbicide, a fungicide or an insecticide on the geographical location 108a. The spray device 202 may be releasably attached or directly mounted to the tractor. The spray device 202 comprises a boom with one or more spray nozzles 204 arranged along the boom of the spray device 202.

One or more tanks 208a-c for containing one or more agricultural substances are shown in fluid communication with the spray nozzles 204 through common fluidic line 222, which distributes contents of any of the tanks 208a-c or a mixture of the contents as released from the tanks 208a-c to the spray nozzles 204. Each of the tanks 208a-c holds one or more agricultural substances for the fluid mixture to be released at any one or more of the geographical locations 108a-d. This may include chemically active or inactive ingredients like a herbicide mixture, individual ingredients of a herbicide mixture, a selective herbicide for specific weeds, a fungicide, a fungicide mixture, ingredients of a fungicide mixture, ingredients of a plant growth regulator mixture, a plant growth regulator, water, oil, or any other formulation agent. Each of the tanks 208a-c may further comprise a respective tank valve (Not shown in FIG. 2) for regulating the dissemination or fluid release from the respective of the tanks 208a-c to the respective fluid line. Such arrangement allows to control the mixture released at any one or more of the geographical locations 108a-d in a targeted manner depending on the conditions sensed at the respective and/or other of the geographical locations 108a-d.

In another example the mixture released at any one or more of the geographical locations 108a-d is controlled by a variable rate application instruction provided via at least one of the computing resources 106, 110, 112 and/or may be loaded to the machine 102 via a computer-readable medium. The variable rate application instruction may generate control signals for the machine 102 and/or the spray device 202.

The dissemination is based on one or more signals retrieved from the machine 102 and/or the spray device 202. Some or all of the signals may be retrieved or obtained, for example, by sensing at the spray device 202 via a detection system 220. The detection system 220 may comprise multiple sensors or detection components 218 arranged along the boom. The detection components 218 may be arranged fixed or movable along the boom in regular or irregular intervals. The detection components 218 may be configured to sense one or more conditions at the geographical locations 108a-d, preferably at the geographical location where the farming operation is conducted. The detection components 218 may be, or they may include an optical detection component for providing an image at the geographical location. Certain optical detection components 218 that are suitable for the present teachings include multispectral cameras, stereo cameras, Infrared (“IR”) cameras, Charge-coupled device (“CCD”) cameras, hyperspectral cameras, ultrasonic or light detection and ranging (“LIDAR”) system cameras. Alternatively, or additionally, the detection components 218 may include further sensors to measure humidity, light, temperature, wind or any other suitable condition on the geographical location.

The detection components 218 may, for example, be arranged perpendicular or nearly perpendicular to the movement direction of the spray device 202 and in front of the spray nozzles 204 (e.g., seen from drive direction).

In the example shown in FIG. 2, the detection components 218 are optical detection components and each of the detection components 218 is associated with a respective of the spray nozzles 204.

In an alternative example at least one of the detection components 218 is a GPS sensor. In such cases the other sensors may not be needed or switched of. The tank valves are then controlled by the variable rate application instruction received via one of computing resources 106, 110, 112 and/or via a computer-readable medium.

In FIG. 2, the control unit 210 is shown located in a main sprayer housing 206, from where it may be operatively coupled via the connectivity interface 104 to the respective components such as sensors and actuators. The connection may be a wired connection to some or all of the components, or it may be a wireless connection. Accordingly, the connectivity interface 104 may allow wired and/or wireless connections.

In order to evaluate whether an operation by loading a variable rate application instruction and/or a digital map to the machine 102, to the spray device 202, to the application device 202 and/or to the control unit 210 is efficient a suitability index may be generated by an apparatus for generating a suitability index.

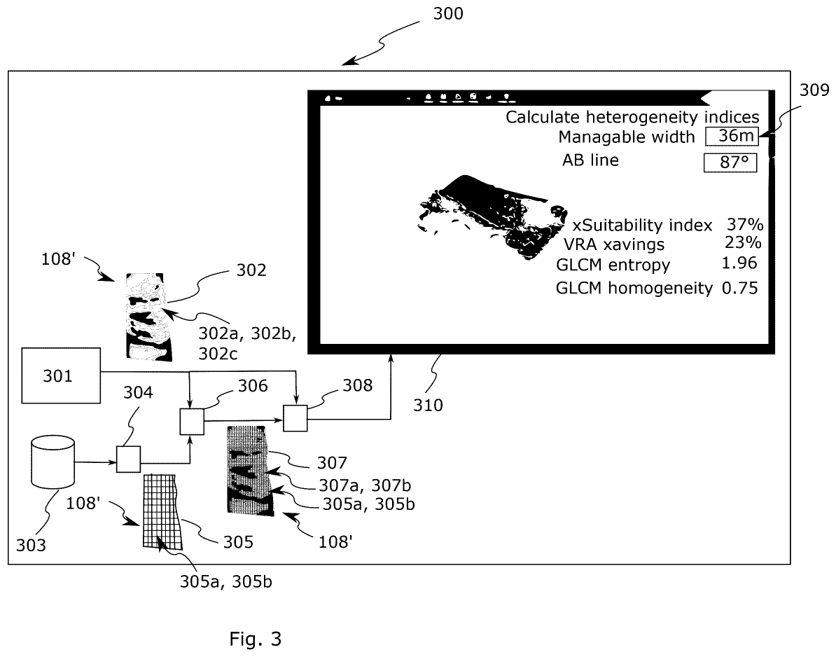

FIG. 3 illustrates a block diagram of an apparatus 300 for generating a suitability index according to an exemplary embodiment of the present invention.

The apparatus 300 for generating a suitability index for the application of an agricultural product to a field 108′ with an application device 202 comprises a vegetation data device 301 for providing vegetation data 302 associated with a biomass distribution 302a, 302b, 302c on the field 108′. The vegetation data 302 is provided as a map 302 with zones 302a, 302b, 302c of biomass which indicate a biomass distribution of the field. 108′. The field 108′ is defined by the border of the map 302. In the example of FIG. 3 the vegetation data 302 is provided as a biomass map 302.

The machinery data device 303 of the apparatus 300 is adapted for providing machinery characteristics associated with a machinery footprint of the application device 202 on the field 108′. In FIG. 3 the machinery data device 303 is realized as a database comprising a plurality of machinery characteristics of typical application devices 202.

The apparatus 300 for generating a suitability index further comprises a machinery cell grid device 304 for generating a machinery cell grid 305 from the machinery characteristics. The machinery cell grid 305 comprises at least one cell 305a, 305b and has the shape of the field 108′. The at least one cell 305a, 305b substantially corresponds to a projection of the footprint of the application device 202 to the field 108′.

The dosage cell grid device 306 is adapted for generating a dosage cell grid 307 from the vegetation data 302 and from the machinery cell grid 305, wherein the dosage cell grid 307 indicates a dosage 307a, 307b for the application of the agricultural product for the at least one cell 305a, 305b of the machinery cell grid 305. The dosage cell grid 307 is derived from an overlay of the machinery cell grid 305 and the vegetation data 302. The dosage values 307a, 307b per cell are derived from the biomass zones 302a, 302b, 302c of biomass map 302 and allocated to the cells 305a, 305b of the machinery cell grid 305. As the dosage values 307a, 307b indicate a quantity and/or a value per cell they may also be understood as the cells with corresponding values within the dosage cell grid 307.

The biomass map 302 as well as the dosage cell grid 307 are forwarded to the suitability index generation device 308. The suitability index generation device 308 generates a matching factor by matching the dosage cell grid 307 and the vegetation data 302 and/or the biomass map 302 and generates the suitability index 309 based on the matching factor. The suitability index 309 is forwarded to the output device 310, e.g. a user interface, and is providing by the output device 310.

In an example the dosage cell grid 307 may be provided as a “to apply map” and/or as a basic map to be used in an application device. Such dosage cell grid 307 may differ from a mere representation of satellite measured vegetation indices by considering sprayer specificity in their “to apply maps”, or by showing “ramping up” prior and/or after high productivity areas. Maps and/or instructions offering such typical patterns may be identified as output product of the disclosed method.

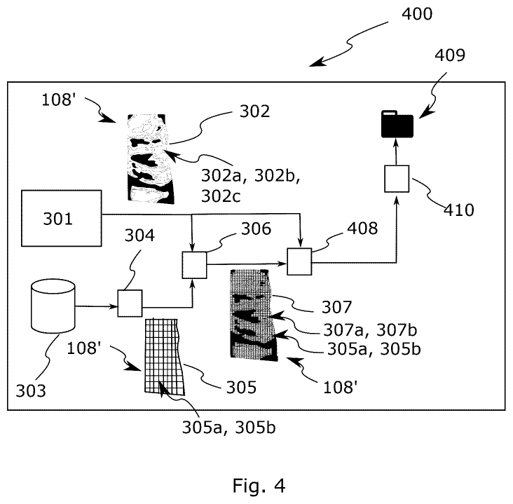

FIG. 4 illustrates a block diagram of an apparatus 400 for generating a variable rate application instruction according to an exemplary embodiment of the present invention.

The apparatus 400 for generating a variable rate application instruction substantially corresponds to the apparatus 300 for generating a suitability index of FIG. 3.

An apparatus 400 for generating a variable rate application instruction for the application of an agricultural product to a field comprises the vegetation data device 301 for providing vegetation data 302 associated with a biomass distribution on the field 108′, a machinery data device 303 for providing machinery characteristics associated with a machinery footprint of the application device 202 on the field 108′.

The apparatus 400 for generating a variable rate application instruction further comprises a machinery cell grid device 304 for generating a machinery cell grid from the machinery characteristics, wherein the machinery cell grid 305 comprises at least one cell 305a, 305b.

The dosage cell grid device 307 is adapted for generating a dosage cell grid 307 from the vegetation data 302 and the machinery cell grid 305, wherein the dosage cell grid indicates a dosage for the application of the agricultural product for the at least one cell.

Instead of the suitability index generation device 308 and/or in addition to the suitability index generation device 308 the apparatus 400 for generating a variable rate application instruction comprises a variable rate application generation device 408. The variable rate application generation device 408 is adapted for generating the variable rate application instruction 409 and/or a set of variable rate application instructions 409 based on the dosage cell grid 307.

The variable rate application instruction 409 is provided to the output device 410 for distributing the variable rate application instruction 409 for the application of the agricultural product to the field 108′ with the application device 202.

The output device 410 may be a device for writing the variable rate application instruction 409 to a computer readable storage medium, e.g. an USB device. In another example the output device 410 for providing the variable rate application instruction 409 may be an adapter which is adapted to provide the variable rate application instruction 409 to an application device via a network and/or a cloud, for example to the connectivity interface 104 and/or to one of the one or more remote computing resources 106, 110, 112.

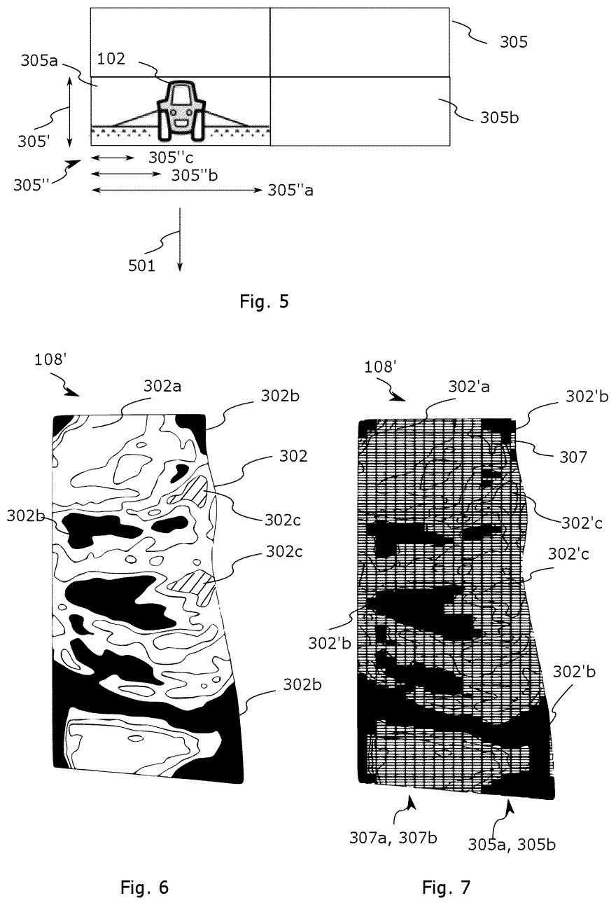

FIG. 5 illustrates a creation schema for generating a machinery cell grid from the machinery characteristics according to an exemplary embodiment of the present invention.

The machinery cell grid 305 comprises cells 305a, 305b. Machine 102 and/or application device 202 has/have some physical dimensions which determine the size of a cell 305a, 305b. The orientation of the cell 305a, 305b and/or of the cell grid 305 is determined by the tramline 501 which has an angle referred to a basic orientation. The length 305′ of a cell 305a, 305b along the tramline 501 is determined by a reaction time of the application device 202, e.g. the reaction time of a sprayer. The reaction time may be influenced by a rate that indicates how fast the properties of the application device 202 are able to be changed. In an example the reaction time may be influenced by the time needed for changing a dose for an application, e.g. a product, a liquid, a seed and/or a fertilizer. The reaction time may be the “sprayer reaction time” after zone changes, e.g. for applying a new dose value to the ground.

The width 305″ of a cell may be determined by a machinery characteristics such as a width of the application device 202. FIG. 5 shows different widths 305″a, 305″b, 305″c, which may correspond to a working width of a full boom 305″a, a half boom 305″b or a section 305″c.

FIG. 6 illustrates a vegetation data map 302 with biomass zones 302a, 302b, 302c according to an exemplary embodiment of the present invention.

A field's 108′ productivity, i.e. its ability to generate a certain crop yield, may vary across its spatial extent. This is due to the spatial variability of confounding factors, such as i.e. topography and soil. A variable rate operation, including but not limited to, variable rate application (VRA) of any product, e.g. plant protection, variable rate seeding (VRS) and variable rate fertilization (VRS), is an attempt to provide a good treatment for every location within the field. Hence, the success of VRA, VRF or VRS, measured in comparison to a flat application, may depend on the spatial distribution of the field's productivity.

This spatial distribution 302 may be shown in the vegetation map 302 and can be characterized by the magnitude of values of a factor and their 2-dimensional dispersion of these values. In an example the field's productivity is grouped into zones 302a, 302b, 302c. The different zones 302a, 302b, 302c may be allocated a specific biomass zone type. These zones 302a, 302b, 302c may indicate the distribution of biomass in a field 108′. Certain threshold values are used for establishing the zones 302a, 302b, 302c. Consequent, a zone 302a, 302b, 302c forms a set of substantially equal measurement values.

A vegetation map 302 with biomass zones 302a, 302b, 302c shows the areal proportion of different zones 302a, 302b, 302c in the field 108′. Further information that may be derived from the vegetation map 302 may be the indication of dominant zones and/or areas with proportions of substantially equal size. A vegetation map also shows whether the zones 302a, 302b, 302c occur structured, randomly dispersed, homogenously and/or clustered.

OFD (Onfarm Development) studies have shown that certain heterogeneity indices may be efficiently used to explore biomass map 302 and/or a vegetation map 302.

Existing indices of heterogeneity, e.g. coefficient of variation, variogram-based, glcm-based, can express a field's 108′ heterogeneity in a single index, derived from a spatial measurement of the variable of interest. In an example a remotely sensed biomass map 302 is provided and a heterogeneity index is calculated.

Examples for heterogeneity indices are the coefficient of variation, variogram-based indices, such as Variogram range, Cambardella. Mean correlation distance. Another example for heterogeneity indices are Grey-Level Co-Occurrence Matrix (GLCM) based features such as GLCM entropy, GLCM autocorrelation, GLCM cluster tendency.

However, such indices are defined for point measurements and/or grey levels but they do not consider zones 302a, 302b, 302c and the ignore the machinery footprint.

The suitability index 309 as described in this text considers both, zone logic of a vegetation map 302 and the machinery footprint that may be provided by the cells 305a, 305b of the machinery cell grid 305. The zone logic of a vegetation map 302 may often be used by field manager applications.

The suitability index 309 presents a field suitability for VRA, VRS and/or VRF. The suitability index 309 considers a machinery footprint 305 and a zone logic 302a, 302b, 302c, e.g. a zone logic 302a, 302b, 302c as provided by a field manager application.

In order to determine a suitability index 309 a match between machinery footprint 305 and/or a machinery cell grid 305 is generated.

FIG. 7 illustrates a dosage cell grid 307 for variable rate application (VRx) according to an exemplary embodiment of the present invention. The dosage cell grid 307 may be seen as a digital map comprising control instructions for an application 202 device in form of dosage information.

The dosage cell grid 307 may be generated when a variable rate application rule VRx, e.g. VRA, VRF, VRS is used as an application concept. The VRx application rule allows for adapting the dosage rate and/or the application rate on the width of the smallest separately controllable part and/or sub-device 305″a, 305″b, 305″c of an application device 202. In this way the zones 302a, 302b, 302c may be matched with the cells 305a, 305b of machinery cell grid 305.

In the example of FIG. 7 the cells 305a, 305b have a rectangular shape 305′, 305″. Consequently, the dosage cell grid 307 comprises a rectangular shape, wherein the size of the dosage cells 307a, 307b, which are indicated by the dosage values per cell 307a, 307b has substantially the same dimensions as the cells 305a, 305b of the machinery cell grid.

In other words, the matching of the substantially round shape of zones 302a, 302b, 302c of biomass are transformed to substantially rectangularly shaped zones of dosage 302′a, 302′b, 302′c and/or dosage zones 302′a, 302′b, 302′c.

Whilst the biomass zones 302a, 302b, 302c are characterized by substantially the same biomass value the dosage zones 302′a, 302′b, 302′c are characterized by substantially the same dosage and/or application rate value 307a, 307b.

Similar to the process of digitalization an analog source such as sound a range of substantially similar biomass values is mapped to substantially one unique dosage rate value 307a, 307b. In this way the substantially round biomass zones 302a, 302b, 302c may be transferred to at least one mosaic-like shaped dosage zone 302′a, 302′b, 302′c.

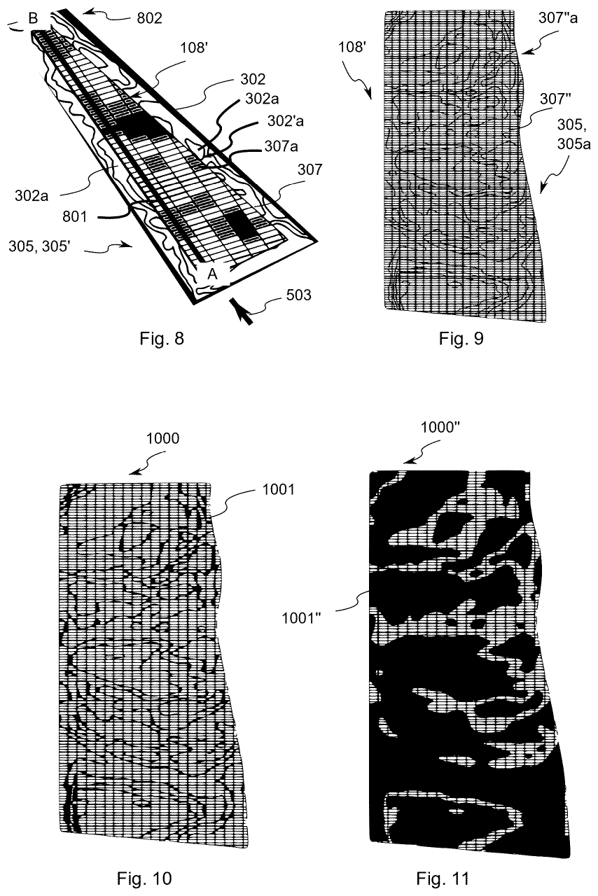

FIG. 8 illustrates a perspective view of dosage cell grid 307 according to an exemplary embodiment of the present invention. This view shows the overlay of the vegetation data map 302 with the mosaic-shaped dosage cell grid 307. FIG. 8 shows as an example how the round biomass zone 302a is matched with and/or transformed to the rectangular dosage zone 302′a.

This dosage zone 302′a comprises three dosage cells 307a and in this way define the dosage value for these cells 307a and consequently for the dosage zone 302′a. The dosage zone 302′a may has a specific biomass zone type.

FIG. 8 also shows the tramline 503 which is substantially oriented in parallel to AB-line 801. Tramline 503 and/or AB-line 801 extends in parallel with the smaller side and/or parallel to the length 305′ of the cells 305a. The orientation of the AB-line 801 may be a degree and/or angle with reference to a reference line such as a North-South-orientation and/or to a meridian. The point B of the AB-line 801 is located in the region of the headland 802.

FIG. 9 illustrates a dosage cell grid 307″ for a flat application of an agricultural product according to an exemplary embodiment of the present invention.

For a flat and/or homogeneous application of an agricultural product to a field 108′ every cell 305a of the machinery cell grid 305 has substantially the same dosage value 307″a and/or biomass zone type. Consequently, the dosage cell grid 307″ for flat application substantially has the same value. In other words, the whole field 108′ is treated with a substantially homogeneous application rate.

FIG. 10 illustrates a difference image 1000 between the vegetation data map 302 of FIG. 6 and the dosage cell grid 307 of FIG. 7 for variable rate application (VRx) of FIG. 6. according to an exemplary embodiment of the present invention.

In the difference image 1000 the difference lines 1001 and/or the difference planes 1001 are a measure for a matching factor and/or for the suitability index 309. The difference planes 1001 are generated when the vegetation data map 302 is subtracted from the dosage cell grid 307. The larger the total amount of the accumulated difference plane 1001 the worse the matching factor and/or the suitability index 309.

As can be derived from the small total difference plane in FIG. 10, 88% of the biomass zones 302a, 302b, 302c correspond to the dosage zones 302′a, 302′b, 302′c of the dosage cell grid 307 for VRx application, e.g. for VRA.

FIG. 11 illustrates a difference image 1000″ between the vegetation data map 302 of FIG. 6 and the dosage cell grid 307″ for flat application of FIG. 9 according to an exemplary embodiment of the present invention.

As can be derived from the large total difference plane 1991″ in FIG. 11, 27% of the biomass zones 302a, 302b, 302c correspond to the homogeneous dosage zone of the dosage cell grid 307″ for flat application.

Consequently, in this particular case for the specific field 108′ of FIG. 6, the application concept of VRx, e.g. VRA matches an addition 61% of the biomass zones compared with the application concept of a flat application.

The suitability index 309 can be seen as an indicator to which degree a field's 108′ heterogeneity may be better matched by VRA than a flat application. The suitability index 309 bases on a zoning logic and considers a machinery footprint 305.

The suitability index 309 may be calculated before the actual application of the product to the field 108′ happens and the suitability index 309 may provide a measure for deciding whether the application of a VRA and/or VRS application concept is advantageous over the flat application.

The suitability index 309 may provide an explanation for the fact that in some cases a VRA application is advantageous and, in some cases, not.

The suitability index 309 is a single index that supports the decision for an application concept, e.g. VRA and/or flat.

The suitability index 309, in particular the VRA suitability Index 309, captures how closely the spatial distribution and/or heterogeneity of a field's productivity can be matched by a variable rate operation VRx. This fact may be expressed in a matching factor which indicates how closely the spatial distribution and/or heterogeneity of a field's productivity can be matched by a variable rate operation VRx. This matching factor may be provided as a percentage value in % and may be compared to a matching factor of a flat rate operation. The matching factors respect the technical footprint of the used machinery 102, 202. In addition, an estimation about the volume of product savings that a grower may expect from a variable rate operation can be provided compared to a flat operation.

Furthermore, a connection between indices of a field's heterogeneity, e.g. the suitability index 309 and VRA success may be investigated and verified by field testing. Field trial research may show that the suitability index alone and/in combination with other indices of within-field biomass heterogeneity has a high correlation with VRA success, compared to other potential drivers like weather, soil, diseases and topography.

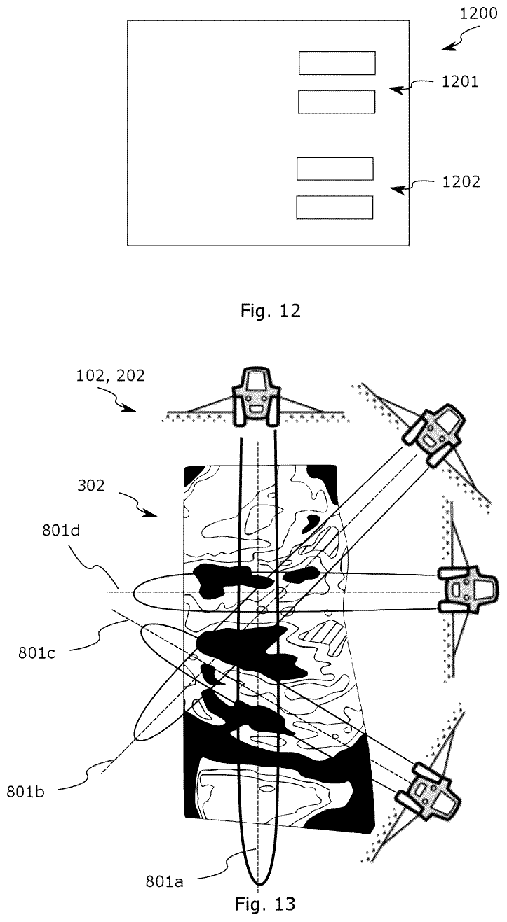

FIG. 12 shows a user interface 1200 for communicating with a computer-implemented method, with an apparatus for generating a suitability index and/or with an apparatus for generating a variable rate application instruction according to an exemplary embodiment of the present invention.

The user interface 1200 has input fields 1201 and output fields 1202. The input fields may be used for supplying the computer-implemented method, the apparatus for generating a suitability index and/or the apparatus for generating a variable rate application instruction with a manageable width value for the cell width 305″ and/or for providing an orientation and/or an angle for the AB-line 801.

The user interface 1200 may provide in the output fields 1202 calculated value for the suitability index 309, savings for applying a variable rate approach VRx, a GLCM entropy value and/or a GLCM homogeneity value.

The computer-implemented method, the apparatus for generating a suitability index and/or the apparatus for generating a variable rate application instruction calculate the suitability index 309 from a field's data layer map and/or from a vegetation data map 302, e.g. a biomass map based on the input parameter provided via the input fields 1201.

Furthermore, a desired heterogeneity index may be selected via the input fields 1201 from the field's data layer map, and the desired heterogeneity index, e.g. the suitability index, may be provided via the output fields 1202.

FIG. 13 illustrates a series of index generation with different orientations according to an exemplary embodiment of the present invention.

The suitability index 309 may be determined for different orientations of AB-lines 801a, 801b, 801c, 801d and/or of tramlines 503. As the suitability index may be generated without physical operation of the machine 102, 202 the suitability index 309, in particular the VRA suitability Index, may be generated with little effort. In this way in addition to the matching of the technical footprint to the VRA a tramline 503 optimization may be conducted. The tramline corresponds to the path the machine takes on the field.

For optimization the grid generated for the technical footprint is projected onto the zone specific vegetation map and the matching of the technical footprint to the requirements of the VRA is conducted for different orientations of the grid which are set by the orientations of AB-lines 801a, 801b, 801c, 801d. From such matching the amount applied may be determined expressed with the suitability index 309. Based on the amount applied for different orientations the orientation with minimal amount applied may be determined. Based on the amount applied for different orientations savings with respect to a reference value such as flat application may be determined. One or more orientations 801a, 801b, 801c, 801d for the tram line as well the corresponding savings may be provided for selection by a farmer.

In addition, a field suitability index for variable rate application may be determined. The suitability index may include the matching of the vegetation map with the machinery footprint and a determination of the degree of matching. From the grid of the machinery footprint the area of the field that includes an application rate matching to the biomass may be determined.

By adapting the vegetation data map 302 to the machinery cell grid 305 and/or to the footprint 305, i.e. by “gridding” the “To-Apply map” 302 or the original map 302 into representations of technical footprints for example defined by sprayer model and/or seeder model used, and by turning the bearing of that grid, and shifting it left and right, each time calculating the match between applied and to-apply rate per grid cell. After trying substantially all possible bearings 801a, 801b, 801c, 801d and/or offset combinations, the bearing and offset which generates the maximum match expressed by the suitability index is provided. Also, the product savings and increase in match provided through this optimization of tramline degree and start point may be provided compared to a reference value.

A result of optimization may be a percentage value of an increase for the suitability index when using a certain AB-line orientation, e.g. an increase of the percentage matched by VRA by 27% with AB-line=76° versus an AB-line at 37°. Or an increase of savings through VRA by 13% with AB-line=316°.

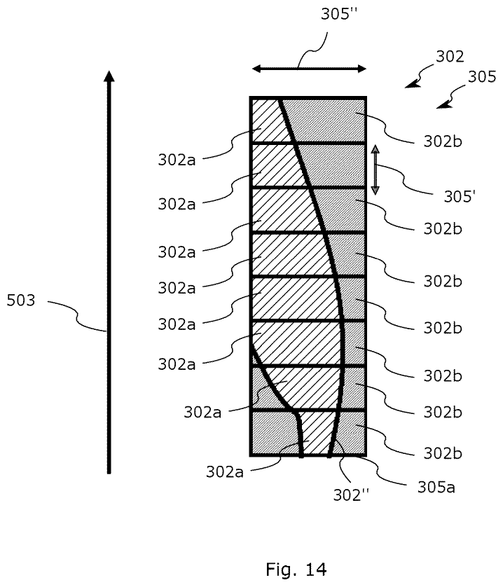

FIG. 14 shows a detail view of an overlay of a vegetation data map 302 with a machinery cell grid 305 according to an exemplary embodiment of the present invention.

The vegetation data map 302 has two biomass zones 302a, 302b.

The tramline 503 shows the direction of the application device, e.g. the moving direction of a sprayer.

The vegetation data map 302 is overlayed with the machinery cell grid, wherein every cell 305a of the machinery cell grid 305 has a length 305′ considering the reaction time and a width 305″, corresponding to a boom width.

As can be seen in FIG. 14, the dimensions 305′, 305″ of the cells 305a overlap the zone border 302″. The zone border 302″ separates the two biomass zones 302a, 302b, e.g. having a different biomass zone type. In the example of FIG. 14, the high biomass zone 302a has a higher value than the low biomass zone 302b.

In order to consider the equipment and the modulation capacity or reaction time the machinery cell grid 305 with cells is used. In the cell 305 only the substantially same dose of agricultural product is used. Thus, the cell 305 may be seen as the smallest resolution for varying the dose and/or dosage of the agricultural product. In other words, the vegetation data map 302 with the biomass zones 302a, 302b is sampled with the machinery cell grid 305. In particular the vegetation data map 302 with the biomass zones 302a, 302b is sampled with a cell 305a and/or with a polygon 305a of the grid 305.

If two and/or a plurality of zones 302a, 302b fall within the plane of a cell 305a a decision may need to be made for allocating a dose 307a for the corresponding cell 305a. An agronomic rule may be used to choose a dose.

TABLE 1

| Biomass zone types | Very Low | Low | Medium | High | Very High |
|---|---|---|---|---|---|
| Water | 80 | 90 | 100 | 110 | 120 |
| quantity | | | | | |
| Product | 0.20 | 0.23 | 0.26 | 0.29 | 0.32 |
| quantity | | | | | |

Table 1 shows 6 types of biomass zones 302a, 302b, 302c which are classified as “Very Low” (L−), “Low” (L), “Medium” (M), “High” (H), “Very High” (H+). Each biomass zone 302a, 302b, 302c has an associated dose 307a, 307b of water and/or dose 307a, 307b of product. In an example the dose 307a, 307b of water and/or dose 307a, 307b of product is mixed in a tank 208a, 208b, 208c.

According to the quantity of the dose the biomass zones 302a, 302b, 302c may be arranged in a predefined order. Thus, in the range from a low quantity to a high quantity the following arrangement for the biomass zone types applies,

“Very Low”< “Low”< “Medium”< “High”< “Very High”.

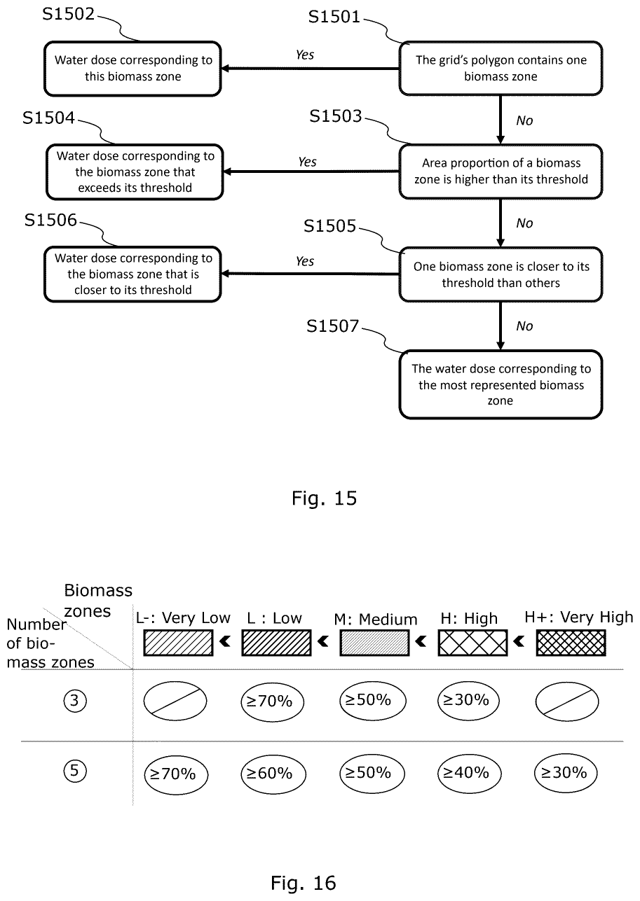

FIG. 15 shows a flow chart for a method of choosing a dose 307a, 307b for a cell according to an exemplary embodiment of the present invention.

The general rules for choosing a dose consider as a principle to always protect the higher zone type. Furthermore, for each grid's polygon 305a, the percentage of occupation by the different biomass zone types is calculated. And when this percentage of occupation with a biomass zone type exceeds the threshold for this biomass zone type, the water dose and/or the product dose associated with this exceeding zone type is allocated as dose value 307a, 307b and/or dose quantity in the entire grid's polygon 305a, 305b and/or cell polygon 305a, 305b.

The threshold for each biomass zone type depends on the number of totally available biomass zone types.

FIG. 16 illustrates a schema for defining thresholds for biomass zone types according to an exemplary embodiment of the present invention.

In order to specify the threshold values a range from 70% to 30% is allocated to the corresponding biomass zone type in such a way that the highest threshold value is allocated to the lowest biomass zone type. This arrangement may help to protect the higher zone type.

If three biomass zone types are available, the threshold values ≥70%, ≥50%, ≥30% are allocated to the biomass zone types Low (L), Medium (M) and High (H), respectively.

If three biomass zone types are available, the threshold values ≥70%, ≥60%, ≥50%, ≥40%, ≥30% are allocated to the biomass zone types Very Low (L−), Low (L), Medium (M), High (H) and Very High (H+), respectively.

In stage S1501 a test is made whether the grid's 305 polygon 305a contains only a single and unitary biomass zone type, i.e. the polygon 305a is free of any zone border 302″. In this case in stage S1502 a water dose and/or a product dose corresponding to this biomass zone type of the corresponding biomass zone 302a, 302b, 302c is selected as dosage value 307a, 307b for this polygon 305a, 305b.

Otherwise, if he grid's 305 polygon 305a contains at least two biomass zone types, in stage S1503 a test is made whether the area proportion of a biomass zone type of the at least two biomass zones 302a, 302b, 302c is higher than its threshold. If this is the case in stage S1504 a water dose and/or a product dose corresponding to the biomass zone 302a, 302b, 302c that exceeds its threshold is selected as dosage value 307a, 307b for this polygon 305a, 305b.

In an alternative example in stage S1503 a test is made whether the area proportion of a biomass zone type of the at least two biomass zones 302a, 302b, 302c is higher than its threshold.

If in stages S1501 to S1503 still no allocation for a polygon 305a, 305b has been made, in stage S1505 a test is made, whether one area proportion of a biomass zone type of the at least two biomass zones 302a, 302b, 302c is closer to its threshold than other area proportion of a biomass zone type. If this is the case a water dose and/or a product dose corresponding to the biomass zone 302a, 302b, 302c that is closer to its threshold is selected as dosage value 307a, 307b for this polygon 305a, 305b.

In an alternative example in stage S1505 a test is made, whether a plurality of and/or multiple biomass zone types exist per grid cell 305a, 305b and/or per grid polygon 305a, 305b, but no threshold is exceeded.

If still no allocation for a polygon 305a, 305b has been made, in stage S1507 a water dose and/or a product dose corresponding to the most represented biomass zone type in the grid polygon 305a, 305b is selected as dosage value 307a, 307b for this polygon 305a, 305b.

In an alternative example in stage S1507 a water dose and/or a product dose is selected to be applied corresponding to the dominant biomass zone type in the grid cell 305a, 305b and/or in the grid polygon 305a, 305b.

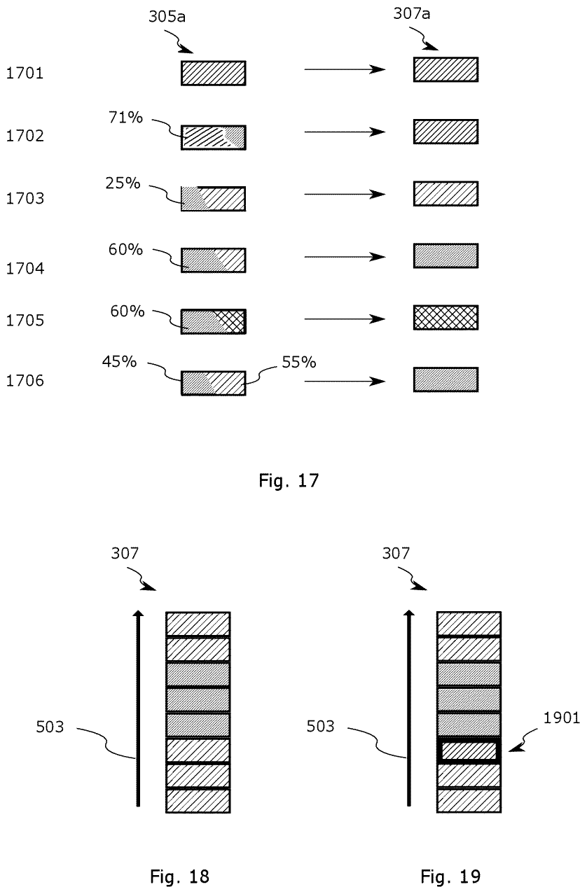

FIG. 17 shows examples for allocating a dosage value 307a, 307b to a polygon 305a, 305b and/or to a cell 305a, 305b according to an exemplary embodiment of the present invention.

In case 1701, the polygon 305a on the left side contains only the single biomass zone type “Very Low” (L−) and therefore the dosage value 307a, 307b “Very Low” (L−) is allocated to the corresponding polygon of the dosage cell grid 307.

In case 1702, the polygon 305a on the left side contains a 71% area proportion or a 71% area share of biomass zone type “Very Low” (L−) and a 29% area proportion of biomass zone type “Medium” (M). Biomass zone type “Very Low” (L−) has a threshold of 70% and biomass zone type “Medium” (M) has a threshold of 50%. Therefore, the dosage value 307a, 307b “Very Low” (L−) is allocated to the corresponding polygon of the dosage cell grid 307.

In case 1703, the polygon 305a on the left side contains a 25% area proportion of biomass zone type “Medium” (M) and a 75% area proportion of biomass zone type “Very Low” (L−). Biomass zone type “Medium” (M) has a threshold of 50% and biomass zone type “Very Low” (L−) has a threshold of 70%. Therefore, the dosage value 307a, 307b “Very Low” (L−) is allocated to the corresponding polygon of the dosage cell grid 307.

In case 1704, the polygon 305a on the left side contains a 60% area proportion of biomass zone type “Medium” (M) and a 40% area proportion of biomass zone type “Very Low” (L−). Biomass zone type “Medium” (M) has a threshold of 50% and biomass zone type “Very Low” (L−) has a threshold of 70%. Therefore, the dosage value 307a, 307b “Medium” (M) is allocated to the corresponding polygon of the dosage cell grid 307.

In case 1705, the polygon 305a on the left side contains a 60% area proportion of biomass zone type “Medium” (M) and a 40% area proportion of biomass zone type “Very High” (H+). Biomass zone type “Medium” (M) has a threshold of 50% and biomass zone type “Very High” (H+) has a threshold of 30%. Therefore, both proportions have the same distance, i.e. 10%, from their threshold values. In order to meet the objective to protect the higher zone the dosage value 307a, 307b “Very High” (H+) is allocated to the corresponding polygon of the dosage cell grid 307

In case 1706, the polygon 305a on the left side contains a 45% area proportion of biomass zone type “Medium” (M) and a 55% area proportion of biomass zone type “Very Low” (L−). Biomass zone type “Medium” (M) has a threshold of 50% and biomass zone type “Very Low” (L−) has a threshold of 70%. Both values are below their thresholds. The difference between the 45% area proportion and the threshold 50% of biomass zone type “Medium” (M) is 5%. The difference between the 55% area proportion and the threshold 70% of biomass zone type “Very Low” (L−) is 15%. Therefore, biomass zone type “Medium” (M) is closer to its threshold than biomass zone type “Very Low” (L−). Consequently, according to stage S1505 the dosage value 307a, 307b “Medium” (M) is allocated to the corresponding polygon of the dosage cell grid 307.

FIG. 18 illustrates a dosage cell grid 307 according to an exemplary embodiment of the present invention.

FIG. 18 shows dosage values 307a and/or dosage instructions 307a per cell after allocating the dose to a machinery footprint 305. Tramline 503 shows the direction of an application device (not shown in FIG. 19).

FIG. 19 illustrates a dosage cell grid 307 with a buffer cell 1901 or buffer zone 1901 according to an exemplary embodiment of the present invention.

In order to prevent a strong change of dose in the tramline 503 direction the dose value of some polygons may be changed. A buffer zone 1901 and/or buffer cell 1901 may be introduced as an intermediate cell 1901 in order to ramp up or ramp down the dosage change in the movement direction.

The intermediate dose 1901 for the buffer zone may be inserted by adapting the reaction time of an application device. The reaction time may generate the length 305′ of a cell and/or polygon.

When an increasing dose change in the tramline direction is detected the value of the grid's polygon in the tramline direction before the higher zone is changed. For example, the buffer zone 1901 of zone type Low (L) is introduced before the cells of type Medium (M) and after the cells of zone type Very Low (L−).

When a decreasing dose change in the tramline direction is detected the dose value 307a, 307b of the grid's polygon in the tramline direction after the higher zone is changed (not shown in FIG. 19).

In an example, buffer zones are introduced before and after the cells of a higher zone.

The agronomic rules S1502-S1507 allow for dosage allocation and help by using the machinery cell grid 305 to vary the resolution and/or the grid for a specific machinery 102 and/or application device 202 in order to adapt size of the cells 305a, 305b to specific machinery characteristics. In this way, the area of a field 108′ on which a machinery 102 and/or application device 202 is acting on may be adapted to the dimensions of the machinery 102 and/or application device 202. In an example the area defined by the machine's manageable width 305″a, 305″b, 305″c, e.g. a boom width, may be used for adapting the resolution of a vegetation map 302 to the machinery 102 and/or application device 202, Furthermore, the reaction time for reacting to changes in an input signal, and the tramline degree and/or tramline angle may be actively used for adapting the resolution. In this way the zones 302a, 302b, 302c may be appropriately treated with an appropriate resolution that takes the zones 302a, 302b, 302c into account.

Varying a machinery cell grid 305 based on machinery characteristics may help to match the resolution on the basis of which an application device 202, e.g. a sprayer, can actually work. The resolution may be defined by the dimension of the cells 305a, 305b of the machinery cell grid 305. In this way the resolution may depend on a boom size and/or the size of another separately manageable sub device of the application device 202 in combination with a tramline degree and a nozzle reaction time for reacting to changes in a control signal. The machinery cell grid 305 may represent a footprint of the application device 202. In an example the machinery cell grid 305 may represent the technical footprint of an individual sprayer model. Different machinery characteristics of different individual sprayer models may be stored in a database and/or in a machinery data device 303.

The machinery cell grid 305 may be used for producing VRA based dose maps and/or for producing instructions from satellite imagery for an individual application device 202. In an example a dosage cell grid 307 may be generated that matches the footprint of an application device 202 and such an individually generated dosage cell grid 307 and/or dosage map 307 may be used in the application device. This dosage map 307 is a map that is applied in the application device and matches with the resolution of the application device 202 and/or with footprint of the application device.

In other words, the resolution by which the agricultural machinery 202 can variably apply plant protection products (A), fertilizer (F), or seeds(S), is limited by a technical footprint 305 of a specific application device model. In an example the technical footprint 305 may be limited by the combination of its boom width 305″a, 305″b, 305″c and/or other manageable device width, a nozzle reaction time 305′ to changes provided with instructions and/or a signal.

Oftentimes, the dimension of an application device intrinsic footprint may exceed the resolution of a map 302. A map 302, e.g. a vegetation data map, may be based on satellite imagery and/or soil sampling.

If the footprint 305 exceeds the resolution of a map 302 the required product rate and the applied product rate may not match. Then the required product rate or the required dosage may vary within one and the same “footprint” and/or within one single cell 305a, 305b.

Intra-field modulation may be offered by VRx application concepts. In order to find a good dosage for each individual cell 305a. This intra-field modulation may be adapted so as to customize the application of doses. This customization may consider the route and/or pattern of a farmer. Furthermore, cutting the field into a grid may help considering the reaction time of the application device 202, e.g. of the sprayer. The headland may be taken into account, the fact that only one dose in each part of the grid can be used is considered and the amount of the agricultural product and/or water is calculated.

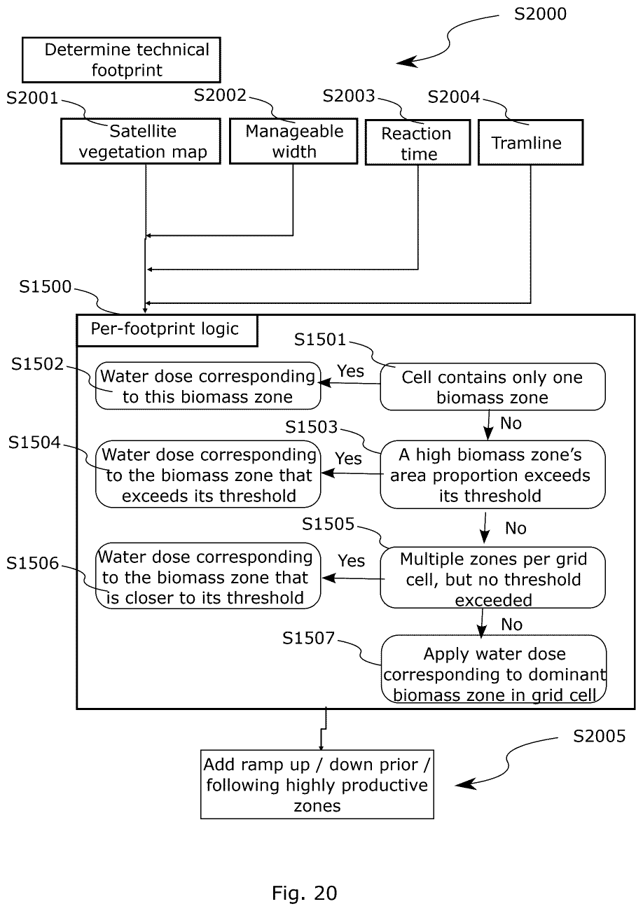

FIG. 20 illustrates a high-level block diagram for a method for generating variable rate application instructions and/or control data for applying an agricultural product to a field 108′ with an application device 202 according to an exemplary embodiment of the present invention.

The method comprises substantially the three functional blocks “technical footprint determination” S2000, the functional block “per footprint logic” S1500, and the functional block “dosage variation” S2005.

Determining a technical footprint may comprise at least one stage of stage S2001 “providing a satellite vegetation map 302” or “providing a satellite vegetation data map 302”, stage S2002 “providing a device 202 with a manageable width 305”, stage S2003 “setting up a reaction time” and stage S2004 “providing a tramline 503”.

Stages S1501 to S1507 of the functional block S1500 “per footprint logic” S1500 substantially are shown in FIG. 15.

Stage S2005 comprises adding a ramp up and/or buffer zone 1901 prior to a highly productive zone and/or adding a ramp down following a highly productive zone.

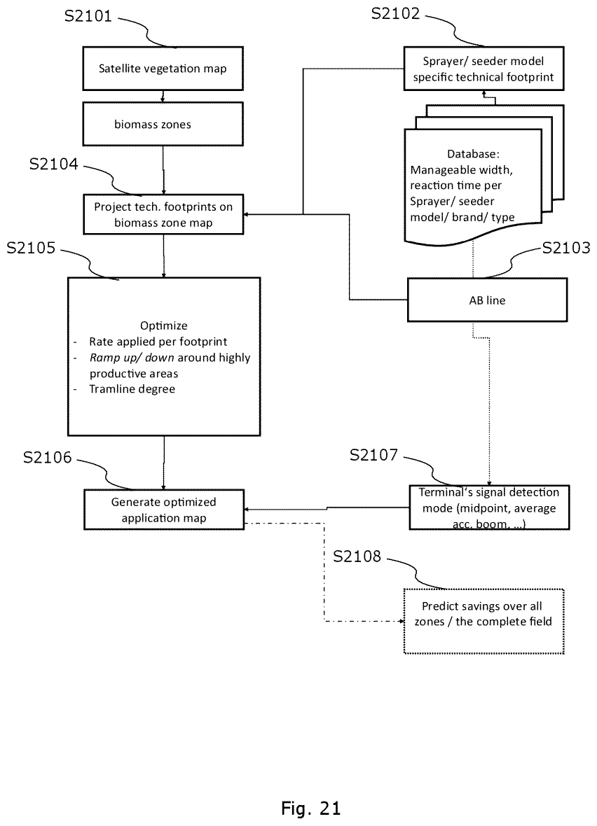

FIG. 21 illustrates a method for generating variable rate application instructions for the application of an agricultural product to a field with an application device 202 according to an exemplary embodiment of the present invention.

In stage S2101 a vegetation data 302 associated with a biomass distribution on a field 108′ is provided. Vegetation data 302 may be provided as a vegetation data map 302 and/or as a remote satellite map 302. The vegetation data 302 may comprise biomass zones.

In stage S2102 machinery characteristics associated with a machinery footprint of the application device on the field are provided. For instance a sprayer and/or seeder model is provided and a specific technical footprint 305 is generated. In other words, a machinery cell grid is generated from the machinery characteristics, wherein the machinery cell grid comprises at least one cell 305a, 305b and/or on polygon 305a, 305b.

Information for generating the footprint 305 may be taken from a database and may comprise the manageable width, the reaction time per sprayer and/or seeder, the model, brand and/or type of the application device 202.

Furthermore, in stage S2103 information about an AB-line 801 may be provided.

In stage S2104 the technical footprint 305 is projected on a biomass zone map 302 or vegetation data map 302.

In stage S2105 a dosage cell grid 307 is generated from the vegetation data and the machinery cell grid wherein the dosage cell grid indicates a dosage for the application of the agricultural product for the at least one cell. The variable rate application instructions are generated based on the dosage cell grid. The variable rate application instructions are provided for application of the agricultural product to the field with the application device.

In stage S2105 different parameter such as rate applied per footprint, ramp up and/or ramp down around highly productive areas and tramline degree are used to optimize a suitability index 309 and/or to generate an optimized application map S2106.

Furthermore, in a terminal's signal detection mode, input parameter such as midpoint, average acc. boom may be provided, as shown in stage S2107.

In stage S2108 savings may be predicted over all zones and/or the complete field 108′.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### LIST OF REFERENCE NUMERALS

102 machine
104 connectivity interface
106 remote server
108, 108a-d geographical location
108′ field
110 field management system
112 client computer
114 crop plant
202 application device, e.g. spray device
204 spray nozzles
206 main sprayer housing
208a-c tanks
210 control unit
212 monitoring system
214, 216 sensors
218 detection components
220 detection system
222 common fluidic line
300 apparatus for generating a suitability index
301 vegetation data device
302 vegetation data map
302a, 302b, 302c zones of biomass
302′a, 302′b, 302′c zones of dosage
302″ zone border
303 machinery data device
304 machinery cell grid device
305 machinery cell grid
305a, 305b cell of the machinery cell grid
305′ length of a cel
305″ width of a cell
305″a width of a full boom
305″b width of a half boom
305″ c width of a section
306 dosage cell grid device
307 dosage cell grid for VRx application
307″ dosage cell grid for flat application
307a, 307b dosage values per cell
307″a dosage value per cell for flat application
308 suitability index generation device
309 suitability index
310 output device for the suitability index
408 variable rate application generation device
409 variable rate application instruction
410 output device for a variable rate application instruction
503 tramline
801 AB-line
801a, 801b, 801c,
801d AB-line orientations
802 headland
1000 difference image for VRx application
1000″ difference image for flat application
1001 difference plane for VRx application
1001″ difference plane for flat application
1200 user interface
1201 input fields
1202 output fields
S1500 functional block “footprint logic”
S1501-S1507 stages
1701, . . . , 1706 examples for dose allocation
1901 buffer cell
S2000 functional block “footprint determination”
S2001-S2004 stages
S2005 functional block “dosage variation”
S2101-S.2108 stages

1. A computer-implemented method for generating a suitability index for the application of an agricultural product to a field with an application device, the method comprising:
providing vegetation data associated with a biomass distribution on the field;
providing machinery characteristics associated with a machinery footprint of the application device on the field;
generating a machinery cell grid from the machinery characteristics, wherein the machinery cell grid comprises at least one cell;
generating a dosage cell grid from the vegetation data and the machinery cell grid, wherein the dosage cell grid indicates a dosage for the application of the agricultural product for the at least one cell;
generating a matching factor by matching the dosage cell grid and the vegetation data;
generating the suitability index based on the matching factor; and
providing the suitability index.

2. The method of claim 1, wherein the machinery characteristics relates to a physical and/or functional setup of the application device.

3. The method of claim 1, further comprising:
providing an application concept for the application of the agricultural product to the field with the application device,
wherein generating the machinery dosage cell grid comprises considering the application concept.

4. The method of claim 3, wherein the application concept is at least one application concept selected from:
an agronomic rule;
a variable rate application rule; and/or
a flat rate application rule.

5. The method of claim 1, wherein generating the machinery cell grid from the machinery characteristics includes at least one of determining the machinery footprint of the application device on the field from a physical dimension of the application device, from control settings of the application device and/or from a reaction time of the application device.

6. The method of claim 3, wherein generating the machinery cell grid from the machinery characteristics includes generating the machinery cell grid based on a sub element of the application device, wherein the sub element is a part of the application device for which the application concept of the agricultural product is separately controllable.

7. The method of claim 1, wherein generating the dosage cell grid comprises:
determining differences between cells;
identifying a buffer cell by the differences; and
assigning an intermediate dosage of the agricultural product to the buffer cell.

8. The method of claim 1, wherein generating the dosage cell grid includes projecting the machinery cell grid in at least one predetermined orientation to the vegetation data and determining the dosage for the application of the agricultural product per cell for the at least one predetermined orientation of the machinery cell grid.

9. The method of claim 8, wherein generating the suitability index based on the matching factor further comprises considering the at least one predetermined orientation of the machinery cell grid.

10. The method of claim 8, further comprising:
determining a tramline for the application device based on the at least one predetermined orientation of the machinery cell grid.

11. The method of claim 1, wherein the dosage for the application of the agricultural product for the at least one cell corresponds to an application rate of the agricultural product per cell.

12. The method of claim 1, further comprising:
providing the dosage cell grid as variable rate instructions for the application of the agricultural product to the field with the application device.

13. The method of claim 12, wherein the variable rate instructions include a variable rate application map indicating the application rate per cell and/or a tramline for the application device.

14. A computer program product for generating a suitability index for the application of an agricultural product to a field with an application device, wherein the computer program product comprises program code, which when executed by a processor is configured to carry out the method of claim 1.

15. An apparatus for generating a suitability index for the application of an agricultural product to a field with an application device, the apparatus comprising:
a vegetation data device for providing vegetation data associated with a biomass distribution on the field;
a machinery data device for providing machinery characteristics associated with a machinery footprint of the application device on the field;
a machinery cell grid device for generating a machinery cell grid from the machinery characteristics, wherein the machinery cell grid comprises at least one cell;
a dosage cell grid device for generating a dosage cell grid from the vegetation data and the machinery cell grid, wherein the dosage cell grid indicates a dosage for the application of the agricultural product for the at least one cell;
a suitability index generation device for generating a matching factor by matching the dosage cell grid and the vegetation data and for generating the suitability index based on the matching factor; and
an output device for providing the suitability index.

16. A computer-implemented method for generating variable rate application instructions for the application of an agricultural product to a field with an application device, the method comprising:
providing vegetation data associated with a biomass distribution on the field;
providing machinery characteristics associated with a machinery footprint of the application device on the field;
generating a machinery cell grid from the machinery characteristics, wherein the machinery cell grid comprises at least one cell;
generating a dosage cell grid from the vegetation data and the machinery cell grid wherein the dosage cell grid indicates a dosage for the application of the agricultural product for the at least one cell;
generating the variable rate application instructions based on the dosage cell grid; and
providing the variable rate application instructions for application of the agricultural product to the field with the application device.

17. An apparatus for generating a variable rate application instruction for the application of an agricultural product to a field, the apparatus comprising:
a vegetation data device for providing vegetation data associated with a biomass distribution on the field;
a machinery data device for providing machinery characteristics associated with a machinery footprint of the application device on the field;
a machinery cell grid device for generating a machinery cell grid from the machinery characteristics, wherein the machinery cell grid comprises at least one cell;
a dosage cell grid device for generating a dosage cell grid from the vegetation data and the machinery cell grid, wherein the dosage cell grid indicates a dosage for the application of the agricultural product for the at least one cell;
a variable rate application generation device for generating the variable rate application instruction based on the dosage cell grid; and
an output device for providing the variable rate application instruction for application of the agricultural product to the field with the application device.

18. An agricultural machinery for application of an agricultural product to a field, wherein the agricultural machine is configured for:
receiving the variable rate application instructions generated by the method according to claim 16, and
applying the agricultural product according to the received variable rate application instructions.

19. A digital map uploadable to an application device, the map comprising:
location-based dosage information,
wherein the location-based dosage information comprises geographical data;
wherein the location-based dosage information forms a dosage cell grid when arranged on a geographical map according to the geographical data;
wherein the dosage cell grid comprises at least one cell of substantially equal dosage values; and
wherein the at least one cell of substantially equal dosage values has a dimension that is associated with a machinery footprint of the application device.
